(19) United States
(12) Patent Application Publication
(10) Pub. No.: US 2005/0050247 A1
(43) Pub. Date: Mar. 3, 2005

(54) Printer with minimal electronics

(76) Inventors: Todd Alan McClelland, Corvallis, OR (US); Patrick Alan McKinley, Corvallis, OR (US); Gregory Frank Carlson, Corvallis, OR (US)

Correspondence Address: AGILENT TECHNOLOGIES, INC.;Legal Department, DL429, Intellectual Property Administration, P.O. Box 7599, Loveland, CO, 80537-0599, US

(21) Appl. No.: 10/649,108

(22) Filed: Aug. 26, 2003

(51) Int. Cl. G06F 3/00

(52) U.S. Cl. 710/52

(57) ABSTRACT

An integrated circuit for a computer peripheral device comprises an interface translator that receives subsystem control instructions from a computer, translates those instructions into an internal format understood by the subsystems of the peripheral device, and passes the instructions to the appropriate subsystem component. The peripheral device requires no processing capabilities. Instead, all of the data processing is performed by a host computer and the host computer's central processing unit (CPU). Appropriate computer peripheral devices for the present invention include printers, scanners, and devices having a combination of functions such as printing, faxing, and copying.

### FIELD OF THE INVENTION

The invention is directed towards electronics and more specifically, towards computer peripherals.

### BACKGROUND OF THE INVENTION

A computer is often used with peripheral devices that have their own internal application specific integrated circuits (ASIC). A printer is one such peripheral device. FIG. 1 shows a typical electronics system in a prior art printer 101. An ASIC 103 and external memory 105 (which may include random-access memory (RAM) and read-only memory (ROM)) are mounted on a printed circuit board 107. The ASIC 103 includes various input/output (I/O) interfaces 109 for communicating with a host computer 104 and with the printer subsystems 106; internal memory 111; a central processing unit (CPU) 113; and image-processing logic 115. The external memory 105 stores the substantial quantities of code and data used by the CPU 113, as well as acting as a buffer for print data coming from the computer.

When a command is issued to print an image, the host computer encapsulates the print data with a page description language (PDL) specific to the operating system (OS) on the computer. For example, computers running a Microsoft windowing operating system typically use a PDL known as a Graphics Device Interface (GDI). The OS PDL is sent to the printer driver, where the printer driver translates the image data into a PDL understood by the printer. Some well-known printer PDLs include PostScript and Printer Control Language. The PDL data is sent from the computer 104 to the printer 101 via an interconnection 117. The printer 101 stores the PDL data in its external memory 105. Next, the printer CPU 113 interprets and processes the PDL data, while the image-processing logic 115 performs a variety of functions on the image. These functions may include: mapping between the color space of the computer and color space of the printer; converting the image from its computer resolution to the printer resolution; and performing region detection to distinguish and sharpen textual portions of the image. Finally, the CPU 113 generates instructions to control and direct the printer subsystems 106 (such as inkjet pens and carriage mechanisms in inkjet printers; or toner cartridges, drum rollers, and lasers in laser printers) to print the image.

Many techniques have been proposed in order to reduce the cost of this existing electronics system 101. For instance, some attempts have been made to integrate the external memory 105 with the ASIC 103, either on a single substrate or through the use of a multi-die package. However, the cost-effectiveness of this solution has yet to be realized due to drastically increased silicon die size, lower silicon yields, expensive packaging costs, and a variety of other factors.

Another approach has been to remove the image processing logic 115 and its associated buffer memory from the ASIC 103 altogether. Instead, the image processing is accomplished by software on the host computer attached to the printer. This reduces the cost of the ASIC 103 and allows the image processing algorithms to be continually improved and updated via new software. Other approaches have moved the printer PDL processing to the host computer, and left the remainder of the print processing steps to the printer CPU. However, even with these improvements, the ASIC 103 remains relatively large and complex.

### SUMMARY OF THE INVENTION

In a preferred embodiment of the present invention, most of the functionality in a printer ASIC is shifted to the host computer. The printer itself requires no processing capabilities. Instead, all of the data processing, image processing, and instruction generation for the printer subsystems is performed by the host computer and the computer's CPU. Therefore, the CPU, image processing logic, and external memory are no longer required on the printer, and the size and complexity of the printer ASIC can be reduced accordingly. Furthermore, the use of a printer PDL may be eliminated altogether.

The computer and the printer communicate via an appropriate high bandwidth interconnection that can accommodate the increased amount of control information and print image data flowing between the printer and computer. The interconnection also has low enough latency to provide timely feedback to the computer. The printer ASIC is reduced to a simple interface translator that translates the interface format used by the interconnection between the printer and computer into an appropriate communication format internal to the printer. The interface translator then directs the control instructions to the appropriate printer subsystem. The printer ASIC includes a small amount of on-chip memory to buffer data between the printer and the computer so as to prevent data starvation during printing due to the inherent latency associated with any type of interconnect between the printer and computer.

This solution substantially reduces the ASIC gate count and pin count, the number of components, the size of the printed circuit board, and the system complexity. Additionally, a standard ASIC can be designed and shared across a large number of product lines since printer feature differentiation is implemented in software on the computer, rather than in hardware on the printer itself. This reduces the cost of printer electronics and allows additional cost reduction due to a larger economy of scale.

Further features and advantages of the present invention, as well as the structure and operation of preferred embodiments of the present invention, are described in detail below with reference to the accompanying exemplary drawings. In the drawings, like reference numbers indicate identical or functionally similar elements.

### BRIEF DESCRIPTION OF THE DRAWINGS

FIG. 1 shows a typical electronics system in a prior art printer.

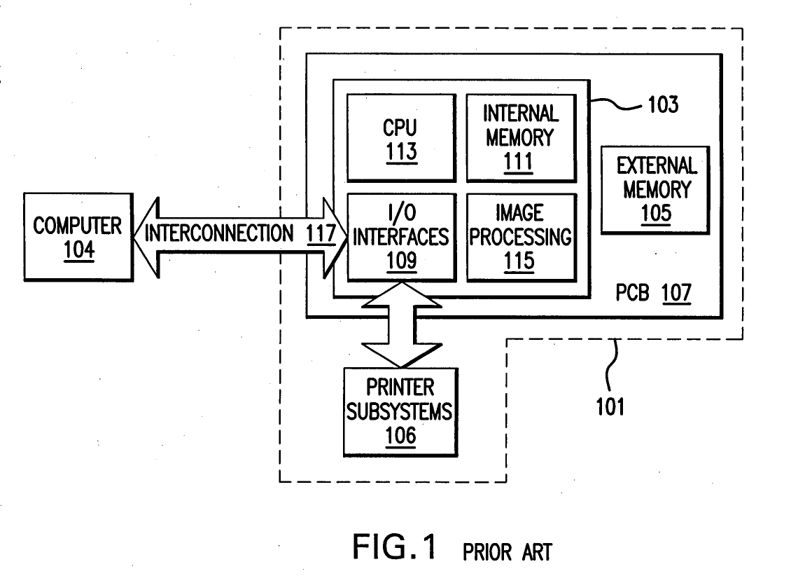

FIG. 2 shows a block diagram of a preferred embodiment, made in accordance with the teachings of the present invention.

FIG. 3 shows a flow chart that illustrates a method according to the teachings of the present invention.

### DETAILED DESCRIPTION

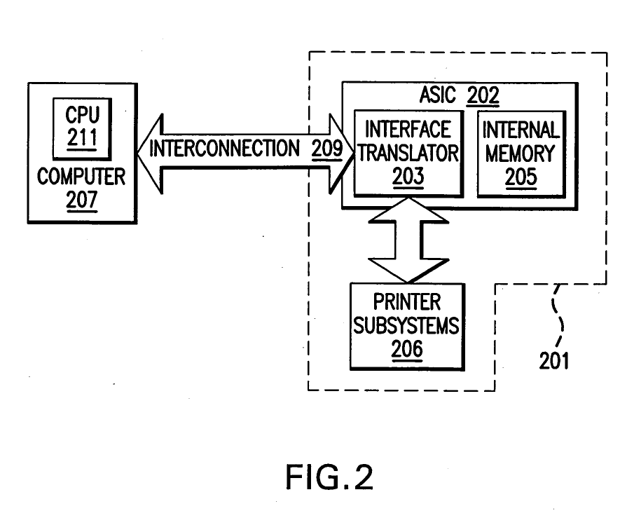

FIG. 2 shows a block diagram of a preferred embodiment made in accordance with the teachings of the present invention. A printer 201 includes an ASIC 202 and subsystems 206. The ASIC 202 has an interface translator 203 and internal memory 205. The interface translator 203 communicates with a computer 207 via an interconnection 209. The interface translator 203 also communicates with the subsystems 206 of the printer 201. The subsystems 206 of the printer 201 may include mechanisms such as inkjet pens, carriages, lasers, toner cartridges, drum rollers, fusers, etc.

The computer 207 has a CPU 211 that is capable of handling the extra image processing requirements and other functionality formerly performed by a prior art printer CPU. Each printer 201 has a corresponding software driver written for it, to be loaded by the CPU 211 when the computer 207 prepares an image for printing. The computer CPU 211 now handles the image processing functions and printer subsystem instruction generation formerly performed by the printer ASIC.

The computer CPU 211 generates instructions for controlling the printer subsystems 206 to print the desired image. Since the printer instructions come directly from the computer, a printer CPU and a printer PDL are no longer needed. Instead, the computer CPU 211 sends instructions directly to the printer 201 through the interconnection 209, and monitors the printer 201 for feedback. The interconnection 209 should have enough bandwidth and low enough latency to ensure reliable data flow and timely feedback between the computer 207 and the printer 201. Suitable interconnection standards include FireWire (also known as IEEE 1394) and USB 2.0, which are well known in the art.

The instructions generated by the CPU 211 directly control the printer subsystems 206 without need for further processing by the printer 201. The computer simply packages the printer instructions into the transmission protocol used by the interconnection. These printer instructions include instructions such as when inkjet pens are supposed to fire, how far a pen carriage needs to travel on the paper, when a paper feeder needs to insert a new page of paper, etc. The interface translator 203 translates the transmitted instructions into an internal format understood by the subsystems 206 and passes the instructions to the appropriate subsystem.

The small internal memory 205 buffers processed image data coming from the computer 207 to ensure that it is delivered on-time to the printer subsystems during printing, as most printers cannot wait for data once printing has begun. The processed image data includes data such as whether a particular color of inkjet is fired or not, or whether a particular toner color is used or not, and requires no further processing by the printer subsystems 206. The size of the internal memory 205 required will vary depending on the type of printer. For example, an inkjet printer can print one swath at a time, whereas a laser printer typically needs to print a page at a time. Therefore, the internal memory 205 required by an interface translator 203 for an inkjet printer may be smaller than the internal memory 205 for a laser printer. The printer instructions may also be buffered, as well.

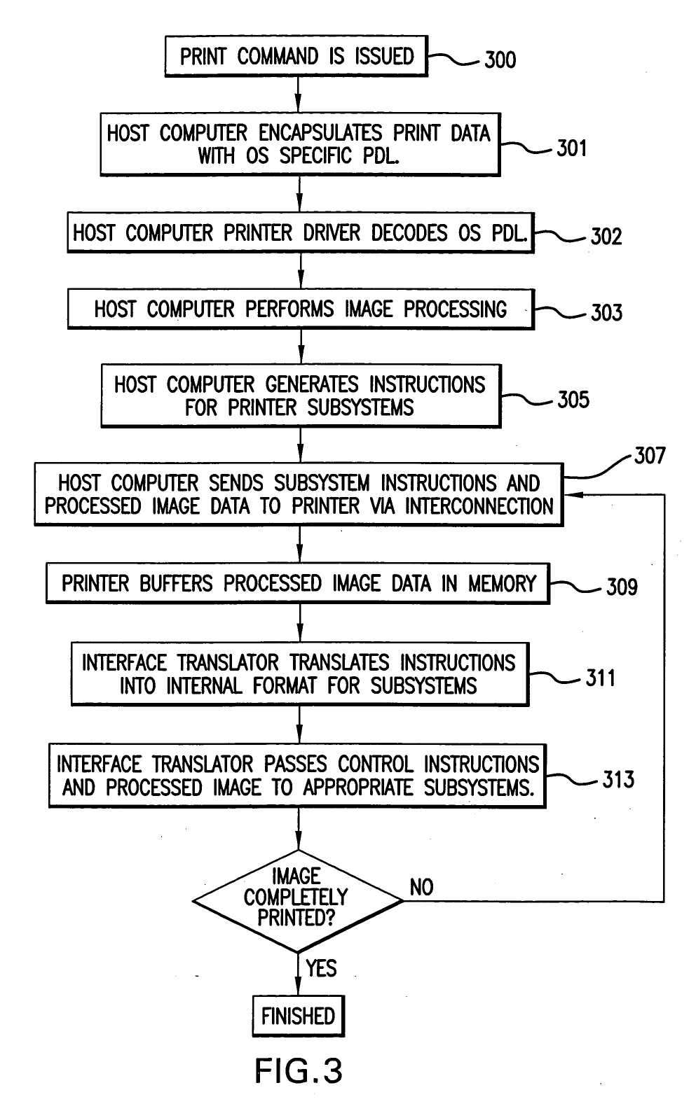

FIG. 3 shows a flow chart for a method according to the present invention. First, in step 300, a print command is issued to the host computer. Subsequently, the host computer encapsulates the image data with an OS-specific PDL in step 301. In step 302, the printer driver on the host computer decodes the OS PDL. Next, in step 303, the host computer performs image processing on the image data. In step 305, the host computer generates control instructions for the subsystems of a printer.

In step 307, the host computer sends the subsystem instructions and processed image data to the printer via an interconnection. The processed image data does not require further processing by the printer. The processed image data includes data such as whether a particular color of inkjet is fired or not, or whether a particular toner color is used or not. Next, in step 309, the processed image data is buffered by the printer in the small internal memory. In step 311, an interface translator in the printer translates the subsystem instruction from the computer into an internal format understood by the subsystems. In step 313, the interface translator passes the instruction onto the appropriate subsystem components, which print the image using the processed image data in the internal memory. The process is finished when the image is finished printing. Otherwise, the process loops back to step 307 to start again with the next instructions from the host computer.

Although the present invention has been described in detail with reference to particular preferred embodiments, persons possessing ordinary skill in the art to which this invention pertains will appreciate that various modifications and enhancements may be made without departing from the spirit and scope of the claims that follow. For example, although the embodiments described above describe the invention with regard to printers, the present invention is applicable to other computer peripheral devices, such as scanners, multi-function printer/fax/copier combination devices, etc.

1. An integrated circuit for a computer peripheral device, comprising:
an interface translator which receives subsystem control instructions from a computer, translates those instructions into an internal format that require no further processing and are understood by the subsystems of the peripheral device, and passes the instructions to the appropriate subsystem component.

2. The integrated circuit as in claim 1, further comprising:
internal memory communicating with the interface translator, for buffering processed data from the computer.

3. The integrated circuit as in claim 1, wherein:
the computer peripheral device includes the capability of printing, and
the instructions control the subsystems to print an image.

4. The integrated circuit as in claim 1, wherein the computer peripheral device includes the capability of scanning.

5. A system, comprising:
a computer having a central processing unit (CPU);
a peripheral device having an interconnection to the computer; and
an interface translator on the peripheral device;
wherein the computer CPU generates control instructions for the subsystems of the peripheral device; and
wherein the interface translator receives subsystem control instructions from the computer CPU, translates those instructions into an internal format that require no further processing and are understood by the subsystems of the peripheral device, and passes the instructions to the appropriate subsystem component.

6. The system as in claim 5, wherein the peripheral device includes the capability of printing, and the instructions control the subsystems to print an image.

7. The system as in claim 5, wherein the peripheral device includes the capability of scanning.

8. A method for printing an image on a peripheral device for use with a host computer, comprising:
receiving subsystem control instructions for printing an image from the host computer;
translating the instructions into an internal format that require no further processing and are understood by the subsystems of the peripheral device; and
passing the instructions to the appropriate subsystem component to print the image.

9. The method as in claim 8, further comprising:
performing image processing and generating subsystem control instructions at the host computer prior to receiving subsystem control instructions.
